(19) United States
(12) Patent Application Publication
(10) Pub. No.: US 2014/0043224 A1
(43) Pub. Date: Feb. 13, 2014

(54) Input Device and Host Used Therewith

(71) Applicant: PIXART IMAGING INC., Hsin-Chu (TW)

(72) Inventor: Yin-Hui Lee, Hsin-chu (TW)

(73) Assignee: PIXART IMAGING INC., Hsin-Chu (TW)

(21) Appl. No.: 13/758,207

(22) Filed: Feb. 4, 2013

(30) Foreign Application Priority Data
Aug. 8, 2012 (TW) 101128536

(51) Int. Cl. G06F 3/01

(52) U.S. Cl. CPC G06F 3/011
USPC 345/156

(57) ABSTRACT

An input device and a host used therewith are provided. The input device comprises a sensor and a transmitter. The sensor senses a physiological feature of a user, and generates a sensing signal. The transmitter, which is electrically connected to the sensor, transmits the sensing signal to the host so that the host identifies the user according to the sensing signal and performs a system configuration according to a setting data corresponding to the user.

This application claims the benefit of priority based on Taiwan Patent Application No. 101128536 filed on Aug. 8, 2012, which is hereby incorporated by reference in its entirety.

### CROSS-REFERENCES TO RELATED APPLICATIONS

Not applicable.

### BACKGROUND OF THE INVENTION

1. Field of the Invention

The present invention relates to an input device and a host used therewith. More particularly, the input device of the present invention can sense a physiological feature of a user and the host can perform a system configuration according to the physiological feature so that a procedure in which the user manually performs the system configuration via the host is eliminated.

2. Descriptions of the Related Art

With rapid development of the science and technologies, people's life relies on the science and technologies more and more heavily and the demands for entertainment are also increased accordingly. Here, take the karaok television (KTV) industry as an example. Apart from the conventional way of choosing songs one by one at the site, a consumer is further allowed to store his/her personal song list and preference settings (e.g., the pitch frequency, the volume, the echo, the sound effect etc.) into a host or a back-end storage device. The song list and the preference settings stored in the host or the back-end storage device are correlated with a personal identification (ID) code (e.g., an ID card number or a member number) of the consumer. Therefore, the consumer can edit the song list and the preference settings by inputting the personal ID code into the host, and read the song list and the preference settings from the host or the back-end storage device so that the host performs a KTV system configuration according to the song list and the preference settings. Furthermore, the user may also use a respective user device to edit the song list and the preference settings through the Internet.

However, it shall be noted that, the consumer must input the personal ID code into the host in order to be identified by the host when he/she desires to edit or read the song list and the preference settings in a KTV place. Thus, this makes the procedure rather complex, which is particularly the case when multiple consumers desire to edit or read their respective song lists and preference settings through the same host respectively within a short period of time.

In view of this, an urgent need exists in the art to provide the consumers with more convenient services to eliminate the aforesaid complex procedure.

### SUMMARY OF THE INVENTION

An objective of the present invention is to provide an input device and a host used therewith. According to the present invention, the input device senses a physiological feature of a user so that the host identifies the user according to the physiological feature and performs a system configuration according to a setting data that has been stored for the user. Accordingly, as compared to the prior art, the present invention can eliminate a procedure in which the user manually inputs the personal ID code into the host.

To achieve the aforesaid objective, the present invention discloses an input device used with a host, which comprises a sensor and a transmitter. The sensor is configured to sense a physiological feature of a user and generate a sensing signal. The transmitter is electrically connected to the sensor and configured to transmit the sensing signal to the host so that the host identifies the user according to the sensing signal and performs a system configuration according to a setting data corresponding to the user.

To achieve the aforesaid objective, the present invention further discloses a host used with an input device, which comprises a receiver and a processor. The receiver is configured to receive a sensing signal from the input device. The sensing signal is generated by the input device through sensing a physiological feature of a user. The processor is electrically connected to the receiver, and is configured to identify the user according to the sensing signal and perform a system configuration according to a setting data corresponding to the user.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a first embodiment of the present invention;

FIG. 2 is a schematic view of a second embodiment of the present invention;

FIG. 3 is a schematic view of a third embodiment of the present invention;

FIG. 4 is a schematic view of a fourth embodiment of the present invention; and

FIG. 5 is a schematic view of a fifth embodiment of the present invention.

### DESCRIPTION OF THE PREFERRED EMBODIMENT

The present invention provides an input device and a host used therewith. In the following descriptions, the present invention will be explained with reference to embodiments thereof. However, these embodiments are not intended to limit the present invention to any specific environments, applications or implementations described in these embodiments. Therefore, description of these embodiments is only for purpose of illustration rather than to limit the present invention. It shall be appreciated that, in the following embodiments and the attached drawings, elements not directly related to the present invention are omitted from depiction.

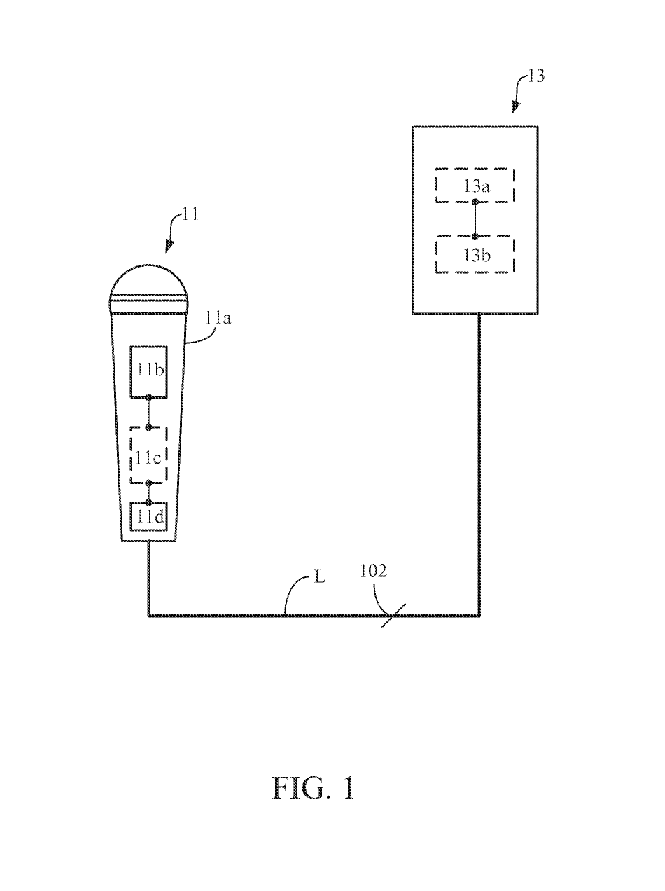

A first embodiment of the present invention is as shown in FIG. 1, which depicts an input device 11 and a host 13 of the present invention. The input device 11 is used with the host 13. The input device 11 comprises a housing 11a, a sensor 11b and a transmitter 11c. The sensor 11b is disposed on a surface of the housing 11a, and the transmitter 11c is disposed in the housing 11a and is electrically connected with the sensor 11b. Furthermore, the input device 11 may (but is not required to) further have a control switch 11d to turn on or turn off the sensor 11b. The host 13 comprises a receiver 13a and a processor 13b. The processor 13b is electrically connected with the receiver 13a.

In this embodiment, the input device 11 is a handheld microphone, and the input device 11 and the host 13 are used in a KTV system and are connected with each other in a wired way through a transmission line L. However, in other embodiments, the input device 11 and the host 13 may be connected with each other in a wireless way and may be used in other audio-video (AV) systems; and the input device 11 may be an earphone microphone or some other input device having the similar input function.

When a user uses the input device 11, the input device 11 is held by a hand of the user so that the sensor 11b makes contact with the hand of the user. At this point, the sensor 11b senses a physiological feature of the user and generates a sensing signal 102. Then, the transmitter 11c transmits the sensing signal 102 to the host 13. The receiver 13a of the host 13 receives the sensing signal 102 from the input device 11. Then, the processor 13b identifies the user according to the sensing signal 102 and performs a system configuration according to a setting data corresponding to the user.

In detail, the sensor 11b may be a heartbeat sensor. In this case, the physiological feature is a heartbeat of the user, and the sensing signal 102 is related to a waveform of the heartbeat of the user. On the other hand, the sensor 11b may also be a fingerprint sensor. In this case, the physiological feature is a fingerprint of the user, and the sensing signal 102 is related to a pattern of the fingerprint of the user. Thus, the processor 13b can identify the user according to the sensing signal 102 and perform the system configuration according to the setting data corresponding to the user.

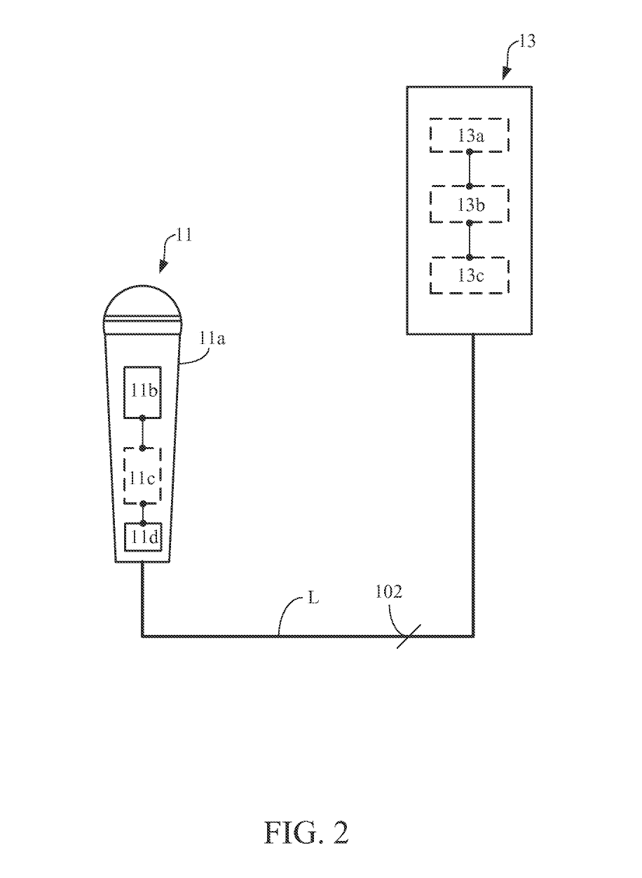

A second embodiment of the present invention is as shown in FIG. 2. Different from the first embodiment, the host 13 in this embodiment further comprises a storage device 13c. The storage device 13c stores a feature database comprising feature values of a plurality of users and stores setting data of a plurality of users. It shall be appreciated that, the feature values of the users stored in the storage device 13c are inputted in advance by the users through the sensor 11b or some other sensor that was once connected to the host 13. Furthermore, the setting data of the users are also inputted in advance by the users through the host 13 or their respective user devices.

After the sensing signal 102 is received by the receiver 13a, the processor 13b generates a feature value according to the sensing signal 102 and compares the feature value with the feature database to identify the user. When the sensor 11b is a heartbeat sensor, the feature value is related to a heartbeat of the user; and when the sensor 11b is a fingerprint sensor, the feature value is related to a fingerprint of the user. For example, when the similarity between a feature value a′ that is generated currently and a feature value a in the feature database exceeds a threshold value (e.g., 90%), the processor 13b performs a system configuration according to a setting data corresponding to the feature value a. It shall be appreciated that, each of the feature values in the feature database may firstly correspond to an ID code of a user and, in turn, the ID code of each of the users may correspond to a setting data. Therefore, those of ordinary skill in the art can readily know from the above disclosures that the feature values may directly or indirectly correspond to the setting data of the users, so any correspondence relationships therebetween that can be devised readily shall all be covered within the scope of the present invention.

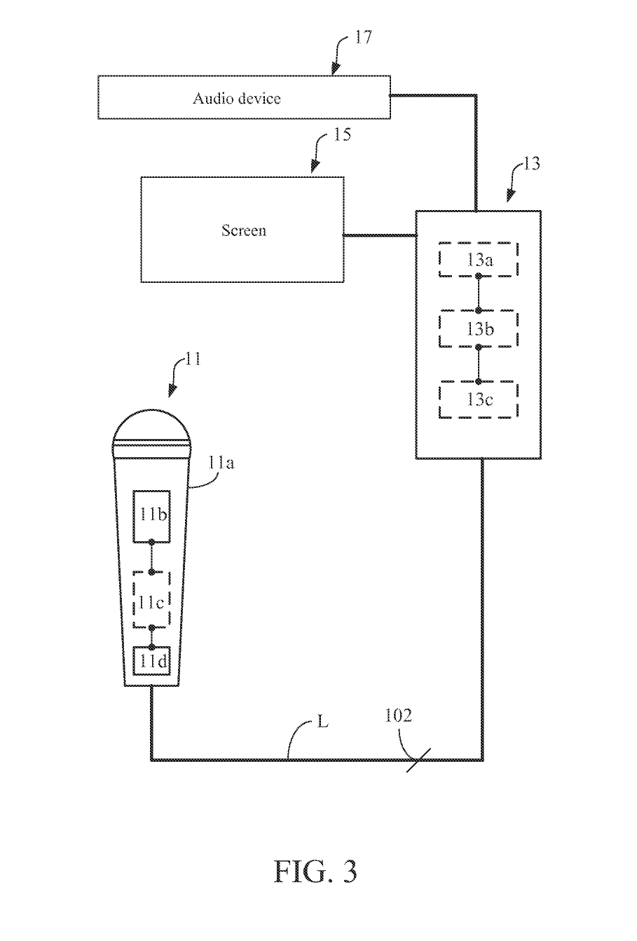

A third embodiment of the present invention is as shown in FIG. 3. Different from the second embodiment, the host 13 in this embodiment is further connected to a screen 15 and an audio device 17. After the user has been identified by the processor 13b, the processor 13b further enables the screen 15 to display an identification result and a control menu. Thus, the user can confirm the identification result through use of the control menu so as to perform the system configuration and adjust the setting data.

Further, in this embodiment, the setting data includes at least one of a tone parameter, a volume parameter, an echo parameter, a sound effect parameter and a track parameter (but is not limited to these parameters). The system configuration performed by the processor 13b is to read related data (e.g., song data related to the track parameter) from a back-end server according to the parameter in the setting data and to adjust an output signal (e.g., an audio signal adjusted according to the tone parameter, the volume parameter, the echo parameter or the sound effect parameter) outputted to the audio device 17.

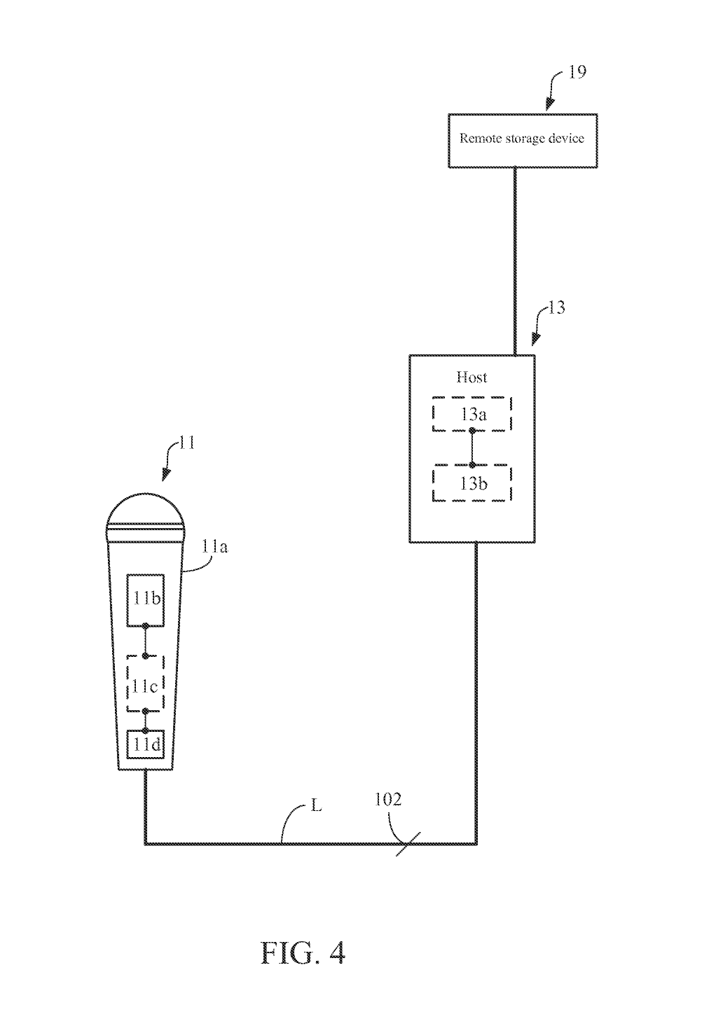

A fourth embodiment of the present invention is as shown in FIG. 4. Different from the first embodiment, the host 13 in this embodiment is further connected to a remote storage device 19. The remote storage device 19 stores a feature database comprising feature values of a plurality of users and stores setting data of a plurality of users. The processor 13b of the host 13 can access the feature database and the setting data from the remote storage device 19 through the receiver 13a. It shall be appreciated that, the feature values of the users stored in the remote storage device 19 are inputted in advance by the users through the sensor 11b or some other sensor that was once connected to the host 13. Furthermore, the setting data of the users are also inputted in advance by the users through the host 13 or their respective user devices.

As is similar to the second embodiment, after the sensing signal 102 is received by the receiver 13a, the processor 13b generates a feature value according to the sensing signal 102 and compares the feature value with the feature database to identify the user. When the sensor 11b is a heartbeat sensor, the feature value is related to a heartbeat of the user; and when the sensor 11b is a fingerprint sensor, the feature value is related to a fingerprint of the user.

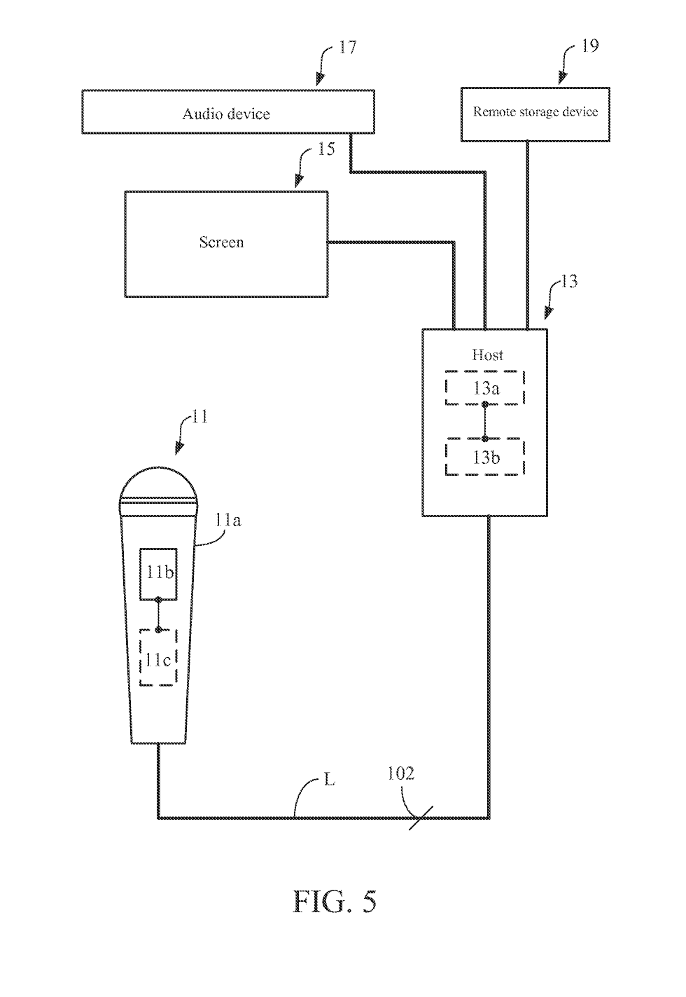

A fifth embodiment of the present invention is as shown in FIG. 5. Different from the fourth embodiment, the host 13 in this embodiment is further connected to a screen 15 and an audio device 17. After the user has been identified by the processor 13b, the processor 13b further enables the screen 15 to display an identification result and a control menu. Thus, the user can confirm the identification result through use of the control menu so as to perform the system configuration and adjust the setting data.

As is similar to the third embodiment, the setting data may include at least one of a tone parameter, a volume parameter, an echo parameter, a sound effect parameter and a track parameter in the fifth embodiment. The system configuration performed by the processor 13b is to read related data from a back-end server according to the parameter in the setting data and to adjust an output signal outputted to the audio device 17.

According to the above descriptions, the present invention provides a convenient and direct identifying mechanism in which the input device senses a physiological feature of a user and the host can directly identify the user according to the physiological feature of the user, and this eliminates the need of manually inputting the personal ID code into the host by the user. Accordingly, as compared to the prior art, the present invention can eliminate the procedure in which the user manually inputs the personal ID code into the host.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An input device used with a host, comprising:
a sensor, being configured to sense a physiological feature of a user and generate a sensing signal; and
a transmitter, being electrically connected to the sensor and configured to transmit the sensing signal to the host so that the host identifies the user according to the sensing signal and performs a system configuration according to a setting data corresponding to the user.

2. The input device as claimed in claim 1, wherein the sensor is a heartbeat sensor, the physiological feature is a heartbeat of the user, and the sensing signal is related to a waveform of the heartbeat of the user.

3. The input device as claimed in claim 1, wherein the sensor is a fingerprint sensor, the physiological feature is a fingerprint of the user, and the sensing signal is related to a pattern of the fingerprint of the user.

4. The input device as claimed in claim 1, wherein the input device is a handheld microphone or an earphone microphone.

5. The input device as claimed in claim 1, wherein the input device is connected to the host in a wireless way or a wired way.

6. The input device as claimed in claim 1, further comprising a control switch being configured to turn on or turn off the sensor.

7. A host used with an input device, comprising:
a receiver, being configured to receive a sensing signal from the input device, the sensing signal being generated by the input device by sensing a physiological feature of a user; and
a processor, being electrically connected to the receiver and configured to identify the user according to the sensing signal and perform a system configuration according to a setting data corresponding to the user.

8. The host as claimed in claim 7, wherein the processor further generates a feature value according to the sensing signal and compares the feature value with a feature database to identify the user.

9. The host as claimed in claim 8, further comprising a storage device being configured to store the feature database and the setting data.

10. The host as claimed in claim 8, wherein the host is further connected to a remote storage device, and the receiver is further configured to access the feature database and the setting data from the remote storage device.

11. The host as claimed in claim 8, wherein the feature value is related to at least one of a heartbeat and a fingerprint of the user.

12. The host as claimed in claim 8, wherein the feature value and the setting data are inputted in advance by the user through the input device and the host.

13. The host as claimed in claim 7, wherein the host is further connected to an audio device, the setting data includes at least one of a tone parameter, a volume parameter, an echo parameter, a sound effect parameter and a track parameter, and the processor performs the system configuration to adjust an output signal outputted to the audio device.

14. The host as claimed in claim 13, wherein the host is further connected to a screen; and the processor further enables the screen to display an identification result and a control menu after identifying the user.

15. The host as claimed in claim 14, wherein the control menu is used to confirm the system configuration and adjust the setting data.

16. The host as claimed in claim 7, wherein the input device is a handheld microphone or an earphone microphone.

17. The host as claimed in claim 7, wherein the host is connected to the input device in a wireless way or a wired way.
